(19) United States
(12) Patent Application Publication
(10) Pub. No.: US 2008/0156179 A1
(43) Pub. Date: Jul. 3, 2008

(54) Logic launcher

(76) Inventor: Paul James Eastman, Hove (GB)

Correspondence Address: PAUL JAMES EASTMAN, 21 FIRST AVENUE, FLAT 6, UNITED KINGDOM, BN3-2FH, omitted

(21) Appl. No.: 11/526,290

(22) Filed: Sep. 25, 2006

Related U.S. Application Data
(60) Provisional application No. 60/720,694, filed on Sep. 28, 2005.

(51) Int. Cl. G10H 7/00

(52) U.S. Cl. 84/645

(57) ABSTRACT

A piece of computer software that runs along-side a computer based music recording studio environment to assist a live performer. When this software receives a MIDI Controller Message sent by the performer, it instructs the computer based studio package to close the previous studio setup and load a different pre-saved studio setup as determined by the Controller message.

### CROSS REFERENCE TO RELATED APPLICATIONS

This application claims priority from Provisional U.S. patent application Ser. No. 60/720,694 filed Sep. 28 2005, which is hereby incorporated in it's entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING APPENDIX

Not Applicable

### BACKGROUND OF THE INVENTION

The idea for this invention derived from working as a Keyboard and Computer technician for touring musicians.

It relates to a piece of computer software designed to assist live performers. This software is intended to run along-side a third party computer based music recording-studio software package, and addresses the problem that such packages provide only a single virtual studio environment.

### BRIEF SUMMARY OF THE INVENTION

When the invented software receives a Controller Message sent by the performer, it instructs the computer based studio software to close the previous studio setup and load a different pre-saved studio environment.

Thus, with any standard Midi Controller keyboard, or any other unit able to sent controller data including MIDI messages, the performing musician can switch between songs as they desire from the onstage keyboard rig.

### BRIEF DESCRIPTION OF THE SEVERAL VIEWS OF THE DRAWING

An example of the invention will now be described by referring to the accompanying drawings.

FIG. 1 shows the comprising elements of a typical live performer setup. It shows the invented software running along-side a piece of music recording studio software, in this case Logic Pro.

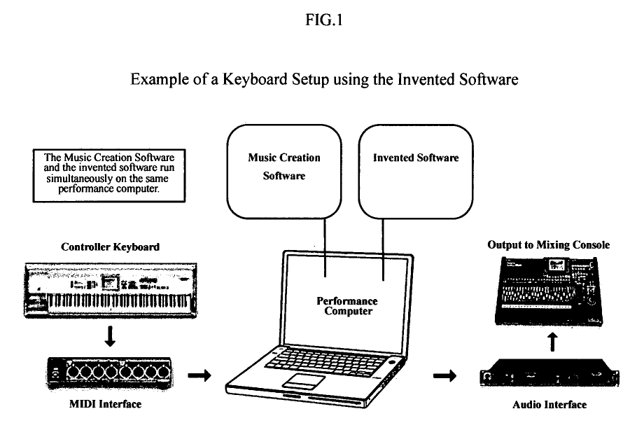

FIG. 2 shows the data flow in our example live setup. We start with the Controller message sent by the performer. This is passed into the computer MIDI interface and is deciphered by the invented software, which in turn, instructs the music recording studio software to close the previous project and load the new project as determined by the Controller message.

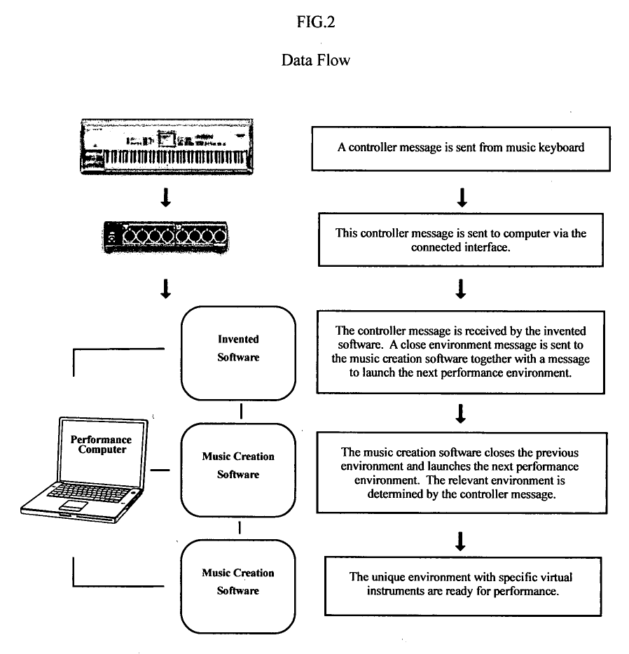

### DETAILED DESCRIPTION OF THE INVENTION

A musical keyboard performance setup utilizing the invented software would have two distinct elements. The first being a keyboard rig consisting of 1 or more MIDI (Musical Instrument Digital Interface) keyboards, and the second, a computer setup comprising of audio and MIDI interfaces, a small mixing console, sound modules and a computer or two. This invention addresses the communication between these two elements.

Logic Pro is a music creation computer package. It was acquired by Apple Computers in 2002 and their latest release, Logic Pro 7 has the following description on the Apple website, “The industry-leading application for music creation and audio production dramatically broadens the capabilities of computer-based studio environments”.

Logic Pro is designed so the user can create a virtual recording studio within their computer. This virtual ‘Environment’ can contain virtual instruments as well as controlling external devices in the users studio setup. For about a year, a few colleagues and myself have been incorporating Logic Pro into the live performance environment. Something that has only been possible due to the stability of Apple's new Operating System OS X. As Logic is designed for studio use, it has only one studio Environment setup per project. This setup would usually need to change between each song for live use.

We overcame this by closing and launching a new Project for each song in a bands set-list. This allows a unique set of Midi and Audio routing for each song so a keyboard player can move instruments around their setup as desired.

The Objective-C computer language, a version of which was adopted by Apple computers when they merged with NeXT Inc. in 1997, is available for use by software developers in Apple's Software Development package, Xcode. This has enabled me to produce a piece of software to run on an Apple computer that can receive and decipher incoming MIDI Program Change messages and then launch the appropriate Performance project within the studio environment software on the performance computer. Most Midi Controller keyboards can send an array of Midi Controller data including Midi Program Change messages.

This essentially means with any standard Midi Controller keyboard or any other unit able to send MIDI controller data, the player can switch between songs as they desire from the onstage keyboard rig.

The process of receiving MIDI Controller Messages by a piece of software running along-side a computer based studio environment, which then instructs this computer based studio package to close and launch a new studio environment for use in a live performance is the fundamental element of this patent application.

1. A piece of computer software which deciphers incoming Controller data and instructs another piece of computer software that has been designed specifically, but not solely for musical creation and that is running on the same computer, to close it's previous setup and load a different pre-saved setup as determined by the Controller message.

2. A piece of computer software according to claim 1, where the Controller data is of a MIDI (Midi Instrument Digital Interface) protocol.

3. A piece of computer software according to claim 1, where the music creation software has been designed specifically, but not solely, for use in a music recording studio environment.

4. A piece of computer software according to claim 1, where the music creation software has been designed specifically, but not solely, for use in a live music performance environment.
